(19) United States
(12) Patent Application Publication
(10) Pub. No.: US 2014/0137751 A1
(43) Pub. Date: May 22, 2014

(54) METHODS AND APPARATUSES FOR A COOKING DEVICE

(71) Applicant: E.G.O. Elektro-Geraetebau GmbH, Oberderdingen (DE)

(72) Inventor: Mathias Bellm, Ubstadt (DE)

(73) Assignee: E.G.O. Elektro-Geraetebau GmbH, Oberderdingen (DE)

(21) Appl. No.: 14/081,349

(22) Filed: Nov. 15, 2013

(30) Foreign Application Priority Data
Nov. 16, 2012 (DE) 10 2012 221 015.6

(51) Int. Cl. G01K 1/02

(52) U.S. Cl. CPC G01K 1/024
USPC 99/342

(57) ABSTRACT

A cooking device, in particular a baking oven, includes a cooking chamber having cooking chamber walls and also a fan opening into the cooking chamber. This fan opening is provided on a fan plate fitted in front of a cooking chamber wall, an antenna being provided for wireless signal transmission with a measuring arrangement which is located in the cooking chamber and has a transceiving antenna. The antenna is arranged between the fan plate and cooking chamber wall and is thus covered or inwardly protected.

### CROSS-REFERENCE TO RELATED APPLICATIONS

This application claims priority to German Application No. 10 2012 221 015.6, filed Nov. 16, 2012, the contents of which are hereby incorporated herein in its entirety by reference.

### TECHNOLOGICAL FIELD

The invention relates to a cooking device, in particular a baking oven, comprising a cooking chamber, which is formed by cooking chamber walls.

### BACKGROUND

It is known from DE 102005046012 B3 to provide a temperature probe in a baking oven as cooking device, the temperature probe having its own antenna, which communicates wirelessly with a further antenna, which is installed fixedly in the baking oven. Here, this antenna of the baking oven is arranged just below the muffle ceiling between windings of a tubular heating element as a heater for the baking oven. It is therefore exposed however both to soiling and potentially to mechanical damage when the baking oven is cleaned.

A similar baking oven is known from DE 102007043370 B3. With this baking oven, the problem of possible damage to the antenna is to be solved by an additional fastening of the free antenna end. The problem of possible soiling still remains unsolved thereby however.

### BRIEF SUMMARY

The object of the invention is to create a cooking device of the type mentioned in the introduction, with which the problems encountered in the prior art can be solved and with which it is in particular possible to create an advantageous arrangement for such an antenna of the cooking device, which preferably involves minimal additional outlay.

This object is achieved by a cooking device, in particular a baking oven. Advantageous and preferred embodiments of the invention are disclosed by the further claims and will be explained in greater detail hereinafter. By express reference, the wording of the claims is made into part of the content of the description.

The cooking device comprises a cooking chamber having cooking chamber walls. In the case of a baking oven, this is what is known as a muffle. The cooking device comprises a fan opening into the cooking chamber, as is known especially of baking ovens, but also of steam cookers. The fan opening itself is provided in what is known as a fan plate, which can also take on a function of an air-guiding plate or can be designed as such and is arranged in front of the cooking chamber wall. Furthermore, an antenna is provided for wireless signal transmission with a measuring arrangement located in the cooking chamber, this measuring arrangement comprising at least one transceiving antenna. There may also be a plurality of antennas. Measuring arrangements of this type are especially temperature measuring arrangements, in particular in the form of electric thermometers or also what are known as roasting skewers, as are known in particular from the aforementioned document DE 102005046012 B3. Here, it should be noted that the fan plate is arranged in a different plane or is separate from the cooking chamber wall in front of which it is arranged. The cooking chamber walls are usually connected to one another integrally and tightly, whereas the fan plate is advantageously placed in front. The fan plate however is arranged at a distance from this cooking chamber wall and from the adjacent cooking chamber walls, at least on one side, advantageously on more or all sides. It also comprises openings or slits or the like, such that air can be drawn in here and is blown out again by the fan of the cooking device toward the fan opening. The fan plate is thus advantageously a part that is additionally fitted in the cooking chamber and that is provided in any case however in order to cover the fan, for example also for air guidance or as an air-guiding plate.

In accordance with the invention, the antenna is arranged between the fan plate and the cooking chamber wall arranged therebehind. The antenna can thus be effectively protected against soiling and also mechanical damage during cleaning or the like. Furthermore, the antenna is therefore located within the cooking chamber however, such that a sufficiently good wireless signal connection to the measuring arrangement is possible, in particular because the fan plate, as has been described beforehand, comprises openings into the cooking chamber.

In a first basic embodiment of the invention, it is possible for the antenna to be fastened to the cooking chamber wall behind the fan plate, in particular to be fastened thereto directly. In doing so, it may rest directly against the cooking chamber wall, for example fastened by means of simple clips or clamps. An electrical connection of the antenna is guided outwardly, in particular through the cooking chamber wall. A cable having a temperature-resistant sheathing or insulation is advantageously used here.

On the one hand, it is possible for the antenna to be arranged in an indentation on the cooking chamber wall. This indentation advantageously points away from the cooking chamber, such that it is possible to arrange the antenna so as to be sunken into the indentation at least partially, preferably entirely. There is therefore no need, at least on account of the antenna, to provide an unnecessarily large distance between the fan plate and the cooking chamber wall.

On the other hand, the antenna may be fitted to the cooking chamber wall with a certain spacing, preferably 1 mm to 10 mm or even up to 20 mm. To this end, a spacer may be used that is in turn fastened to the cooking chamber wall. For example, it is possible to use an insulating feed-through part through the cooking chamber wall as a spacer, in which the aforementioned cable also runs as an electrical connection. Furthermore, it is also possible to design the antenna as an angled profile for example and to mount the antenna via the angled part in a feedthrough through the cooking chamber wall. An aforementioned feed-through part can also be used for this purpose, advantageously made of electrically insulating material such as temperature-resistant plastic or ceramic.

The antenna is advantageously held in the spacer, for example is surrounded thereby. It is particularly advantageously inserted into the spacer via one end and is arranged therein in a sealed manner. The aforementioned guidance of the electrical connection can thus be implemented effectively and the tightness of the cooking chamber can be ensured.

The feed-through part should generally be attached to the antenna in a substantially airtight manner or closely or should even surround the antenna at least in part, such that there is no formation of an undesirable opening from the cooking chamber into the interior of the cooking device behind the cooking chamber wall.

In a second basic embodiment of the invention, it is possible to fasten the antenna to the rear face of the fan plate. Here, the same fastening means in principle as on the cooking chamber wall can be provided, that is to say clips or clamps that themselves are in turn fastened to the fan plate. It is indeed possible in principle to also provide an aforementioned indentation for the antenna on the fan plate. This indentation however would interrupt a surface of the fan plate into the cooking chamber, said surface otherwise advantageously being as smooth as possible, and therefore areas that are difficult to clean could be produced here and are actually to be avoided. An electrical connection of the antenna to the cooking device can again be formed as a cable, as mentioned before, which must run through the cooking chamber wall. Here too, an aforementioned feed-through part can again be provided for this purpose.

In a further embodiment of the invention, an impeller of the fan is arranged between the cooking chamber wall and the fan plate. The impeller is advantageously arranged immediately behind the fan opening, the fan opening possibly comprising a grid or the like so that, in particular during operation of the fan, no objects can be inserted through the fan opening, which could interrupt the operation of the fan or damage the impeller. A fan motor for the fan is advantageously arranged outside the cooking chamber behind the cooking chamber wall and is provided with a substantially sealed feedthrough for a fan shaft supporting the impeller.

In an advantageous embodiment of the invention, the antenna is arranged lower than a fan or lower than the fan opening in the fan plate. The antenna can thus be covered by the fan plate, as considered in the direction of an access door to the cooking chamber or as considered in the direction into the cooking chamber. Furthermore, the antenna does not interfere with the airflow generated by the fan and exiting from the fan opening if it is not arranged immediately behind the fan opening.

In a modification of the invention, it is also possible to arrange the antenna not below the fan opening, but laterally therebeside or thereabove. This is also dependent for example on the size of the cooking chamber and the position of the fan opening on the fan plate. The advantage of an antenna that is rather arranged relatively high lies in the fact that a wireless signal connection is then oriented upwardly from the mentioned measuring arrangement to the antenna as a radio link and therefore cannot be impaired or interrupted by a baking tray or the like on which food to be cooked is located with the measuring arrangement therein.

Preferably, the antenna is arranged behind the fan plate, whereas the fan plate may be closed in front of the antenna when viewed from the cooking chamber. This means that there is no direct opening in the fan plate between the antenna and the cooking chamber, consequently barring a direct line of sight between the antenna and the cooking chamber. This keeps the antenna from being polluted. The electro-magnetic signals can be radiated nonetheless.

It is possible for the antenna to be arranged completely between the fan plate and the cooking chamber wall. That means that no part of the antenna stands out from this space between the fan plate and the cooking chamber wall, so that the antenna is well protected from mechanical damage, for example by cleaning the cooking chamber, as well as also from being polluted.

A length of the antenna is usually, for example, a quarter of the wavelength, that is to say is dependent on frequency. It may be a few cm long, advantageously 2 cm to 25 cm, particularly advantageously approximately 10 cm to 20 cm. The length preferably corresponds to a quarter of the wavelength, and is therefore 2.4 GHz at 2 cm. The antenna can in principle be oriented arbitrarily, but is advantageously oriented horizontally with an arrangement below or above the fan opening.

These and further features will emerge from the claims and also from the description and the drawings, wherein the individual features can be implemented individually or jointly in the form of secondary combinations in an embodiment of the invention, and can be applied to other fields and may represent advantageous embodiments also patentable per se, for which protection is claimed here. The division of the application into individual sections and sub-headings does not limit the general validity of the statements made under the sections and sub-headings.

### BRIEF DESCRIPTION OF THE SEVERAL VIEWS OF THE DRAWINGS

Exemplary embodiments of the invention are illustrated schematically in the drawings and will be described in greater detail hereinafter. In the drawings:

FIG. 1 shows a view from the front of a baking oven according to the invention as cooking device with fan plate and antenna arranged therebehind, and

FIG. 2 shows a side view of the arrangement of the antenna behind the fan plate.

### DETAILED DESCRIPTION

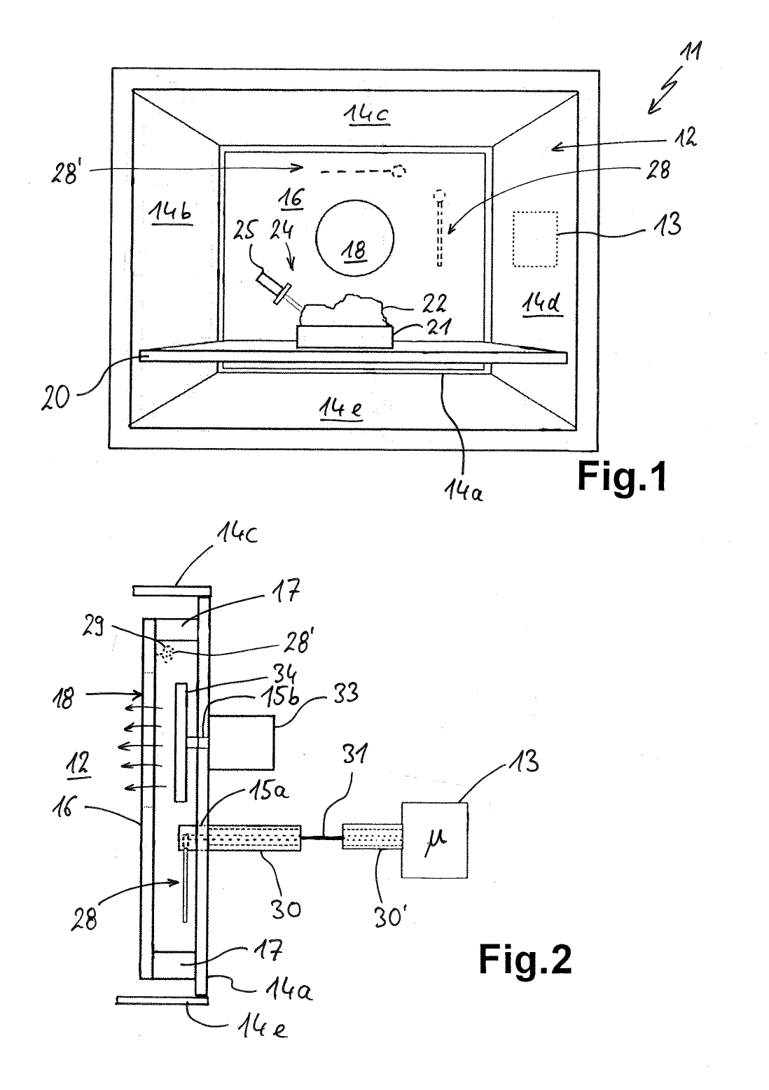

A baking oven 11 as a cooking device according to the invention is illustrated in FIG. 1 in a view from the front without a door. The baking oven 11 comprises a cooking chamber 12, usually also referred to as a cavity or muffle, and also a controller 13 illustrated schematically. The cooking chamber 12 is formed by cooking chamber walls 14, wherein a cooking chamber wall 14a forms a rear face, a cooking chamber wall 14b forms a left side, and a cooking chamber wall 14d forms a right side. The upper face is formed by a cooking chamber wall 14c, and the lower face is formed by a cooking chamber wall 14e. It can be seen, in particular also from the side view in FIG. 2, that a fan plate 16 is installed in front of the rear cooking chamber wall 14a and can also be considered as an air-guiding plate.

It can be seen that the fan plate 16, at the sides, is not quite as large as the cooking chamber wall 14a or does not obscure it completely. The air-guiding plate may also be directly connected at the edge, for example screwed, to the cooking chamber rear wall. By means of slits in the fan plate 16, which are not illustrated here, but are easily produced, air can reach behind the fan plate, as will be explained hereinafter. In addition, a fan opening 18 which is round in shape is located in the fan plate 16. In practice, the fan opening may be provided with grids, bars or the like. It can be seen from the side illustration in FIG. 2 that the fan plate 16 is fastened by means of spacers 17 to the cooking chamber wall 14a, for example is screwed thereto.

A baking tray 20 with a roasting tin 21 and a joint of meat 22 therein is located in the cooking chamber 12. What is known as a roasting skewer 24 is pushed into the joint of meat 22, as is known in particular from the previously mentioned document DE 102005046012 B3. At the front tip (not illustrated), the skewer comprises a temperature sensor for measuring the core temperature of the joint of meat 22. This measured temperature is to be transmitted to the controller 13, for which purpose the roasting skewer 24 comprises a measuring antenna 25, advantageously at its end protruding from the joint of meat.

For wireless signal connection to the measuring antenna 25, an antenna 28 is arranged fixedly on the baking oven 11 and is connected to the controller 13, as can be seen from FIG. 2. On the whole, different positions for the antenna 28 are illustrated here, more specifically a position to the right beside the fan opening 18 at approximately the same height and with vertical orientation in FIG. 1. Furthermore, an antenna 28′ is illustrated in a dashed manner above the fan opening 18 with horizontal orientation. Another further position of the antenna 28 is illustrated in FIG. 2, more specifically below the fan opening 18. If a plurality of antennas are provided, they may thus be arranged in all of these positions.

It can be seen from FIG. 2 that the antenna 28 is fastened to the rear cooking chamber wall 14a. A feed-through part 30, advantageously made from temperature-resistant plastic or ceramic, is used for this purpose. The antenna 28 is inserted into an end of the feed-through part 30 protruding beyond the cooking chamber wall 14a and is thus mounted on said feed-through part. A connection cable 31, which in particular is formed as a coaxial cable, runs through a channel in the feed-through part 30 to the controller 13, wherein a shielding 30′ may also possibly be provided here. The feed-through part 30 itself is guided through a corresponding opening 15a in the cooking chamber wall 14a and sits there with an accurate fit. On the one hand, it may thus be fastened therein. On the other hand, the opening 15a should be sealed where possible, so that no hot air escapes from the cooking chamber 12. This would not be good in terms of energy and in particular would negatively influence or damage the areas behind the cooking chamber wall 14a, that is to say outside the cooking chamber 12.

The antenna 28 itself is advantageously formed from metal and may be a rod or pipe with a length from approximately 2 cm to 25 cm, advantageously 10 cm to 20 cm, in some circumstances also slightly shorter or slightly longer. Here, the antenna 28 is mounted in the feed-through part 30 in such a way that it is mechanically fastened and is held in the desired position. At the same time, the feed-through part 30 seals the opening 15a in the cooking chamber wall 14a and protects the inner connection cable 31. It can be easily seen that the antenna 28 could also be arranged closer to the fan plate 16 or very closely in front of the cooking chamber wall 14a.

The connection between the antenna 28 and the feed-through part 30 should not only be held mechanically, but should also be substantially tight or airtight. A previously described escape of hot air from the cooking chamber 12 can thus be avoided, and, in addition, the inner connection cable 31 is also better protected against excessively high temperatures.

The alternative arrangement of the antenna 28′ in horizontal orientation is illustrated in dashed form at the top of FIG. 2 with a clamp 29. This clamp 29 is fastened to the rear face of the fan plate 16. The arrangement and fastening of the antenna 28′ to the fan plate 16 itself is thus possible. In order to guide an electrical connection cable (not illustrated here) outwardly through one of the cooking chamber walls 14, a feed-through part similar to the feed-through part 30 can again be used.

The fan motor 33 provided on the rear face of the cooking chamber wall 14a is also illustrated in FIG. 2 and drives an impeller 34. To this end, the motor shaft runs through an opening 15b in the cooking chamber wall 14a, said opening advantageously likewise being sealed. The antenna 28 or 28′ maintains a slight distance from the impeller 34.

It can also be seen from FIG. 2 that the impeller 34 can blow air drawn in through the fan plate 16 into the cooking chamber 12 or in the direction of the joint of meat 22 through the fan opening 18. Here, the hot air heating element, which heats the air over its path back into the cooking chamber 12, is usually arranged around the impeller 34.

The possibility of how an antenna 28 or 28′ may be arranged in an indentation in the cooking chamber wall 14a or the fan plate 16 is not illustrated in FIG. 2. This is easily conceivable however for a person skilled in the art on the basis of FIG. 2. Furthermore, it can be seen from FIG. 2 that both the antenna 28 and the antenna 28′ are shielded or covered with respect to the cooking chamber 12 and are therefore protected both against soiling and against damage. The radio link to the measuring antenna 25 of the roasting skewer 24 is slightly impaired here. It is possible however to position the one antenna or the plurality of antennas such that the radio link is still ultimately sufficiently good.

In the modification of the invention that can be easily seen from FIG. 2, the antenna 28 may also be fastened to one of the spacers 17 for the fan plate 16, similarly to the manner in which it is fastened to the feed-through part 30. If the spacer 17 is then also hollow, a connection cable of the antenna 28 can again be guided here from the cooking chamber 12 or through the cooking chamber wall 14a, as is the case with the feed-through part 30. A further opening 15a in the cooking chamber wall 14a can thus be saved.

It can be seen that the antenna 28 or 28′ is arranged behind the fan plate 16 aside from the fan opening 18, whereas the fan plate 16 is closed in front of the antenna when viewed from the cooking chamber 12. There is no direct opening or the like in the fan plate 16 between the antenna 28 or 28′ and the cooking chamber 12, so a direct line of sight between the antenna and the cooking chamber 12 is barred. This keeps the antenna from being polluted, whereas the electro-magnetic signals can be radiated nonetheless.

It is advantageous for the antenna 28 or 28′ to be arranged completely between the fan plate 16 and the cooking chamber wall 14a. So no part of the antenna 28 or 28′ stands out from this space between the fan plate 16 and the cooking chamber wall 14a for the antenna to be well protected from mechanical damage by using or cleaning the cooking chamber 12 and also from being polluted.

That which is claimed:

1. A cooking device comprising:
a cooking chamber comprising cooking chamber walls;
a fan opening into said cooking chamber, said fan opening being provided on a fan plate fitted in front of a cooking chamber wall; and
an antenna being provided for wireless signal transmission with a measuring arrangement, said measuring arrangement being located in said cooking chamber and comprising a transceiving antenna, wherein said antenna is arranged between said fan plate and said cooking chamber wall.

2. The cooking device as claimed in claim 1, wherein said antenna is fastened to said cooking chamber wall behind said fan plate.

3. The cooking device as claimed in claim 2, wherein said antenna is fastened to said cooking chamber wall behind said fan plate by means of an outwardly guided electrical connection.

4. The cooking device as claimed in claim 2, wherein said antenna is arranged in an indentation in said cooking chamber wall.

5. The cooking device as claimed in claim 2, wherein said antenna is fitted to said cooking chamber wall at a distance.

6. The cooking device as claimed in claim 5, wherein said antenna is fitted to said cooking chamber wall at a distance by means of a spacer, said spacer being formed by an insulating feed-through part through said cooking chamber wall, said electrical connection also running in said feed-through part.

7. The cooking device as claimed in claim 6, wherein said antenna is held in said spacer.

8. The cooking device as claimed in claim 6, wherein said antenna is surrounded by said spacer or is inserted thereinto via an end and is arranged therein in a sealed manner.

9. The cooking device as claimed in claim 1, wherein said antenna is arranged behind said fan plate.

10. The cooking device as claimed in claim 9, wherein said fan plate is closed in front of said antenna when viewed from said cooking chamber so that there is no direct opening in said fan plate in the line of sight between said antenna and said cooking chamber.

11. The cooking device as claimed in claim 1, wherein said antenna is fastened to said rear face of said fan plate.

12. The cooking device as claimed in claim 11, wherein said antenna is fastened to said rear face of said fan plate by means of an outwardly guided electrical connection.

13. The cooking device as claimed in claim 1, wherein an impeller of said fan is arranged between said cooking chamber wall and said fan plate.

14. The cooking device as claimed in claim 13, wherein said impeller is arranged immediately behind said fan opening, a fan motor being arranged outside said cooking chamber behind said cooking chamber wall.

15. The cooking device as claimed in claim 1, wherein said antenna is arranged lower than a fan or lower than said fan opening in said fan plate.

16. The cooking device as claimed in claim 15, wherein said antenna is covered by said fan plate, as considered in the direction toward an access door to said cooking chamber, and is not arranged immediately behind said fan opening in said direction.

17. The cooking device as claimed in claim 1, wherein said antenna is arranged completely between said fan plate and said cooking chamber wall.
